(19) United States
(12) Patent Application Publication
(10) Pub. No.: US 2011/0241987 A1
(43) Pub. Date: Oct. 6, 2011

(54) INTERACTIVE INPUT SYSTEM AND INFORMATION INPUT METHOD THEREFOR

(75) Inventor: BRIAN L.W. HOWSE, Calgary (CA)

(73) Assignee: SMART Technologies ULC, Calgary (CA)

(21) Appl. No.: 12/752,904

(22) Filed: Apr. 1, 2010

(51) Int. Cl. G06F 3/033

(52) U.S. Cl. 345/158

(57) ABSTRACT

An interactive input system comprises at least one light source configured for emitting radiation into a region of interest, a bezel at least partially surrounding the region of interest and having a surface in the field of view of the at least one imaging device, where the surface absorbs the emitted radiation and at least one imaging device having a field of view looking through a filter and into the region of interest and capturing image frames. The filter has a passband comprising a wavelength of the emitted radiation.

### FIELD OF THE INVENTION

The present invention relates to an interactive input system and to an information input method therefor.

### BACKGROUND OF THE INVENTION

Interactive input systems that allow users to inject input (e.g. digital ink, mouse events etc.) into an application program using an active pointer (e.g. a pointer that emits light, sound or other signal), a passive pointer (e.g. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference in their entirety; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Patent Application Publication No. 2004/0179001 to Morrison et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally along the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

Although many different types of interactive input systems exist, improvements to such interactive input systems are continually being sought. It is therefore an object of the present invention to provide a novel interactive input system and a novel information input method therefor.

### SUMMARY OF THE INVENTION

Accordingly, in one aspect there is provided an interactive input system comprising at least one light source configured for emitting radiation into a region of interest, a bezel at least partially surrounding the region of interest and having a surface in the field of view of the at least one imaging device, the surface absorbing the emitted radiation, and at least one imaging device having a field of view looking through a filter and into the region of interest and capturing image frames, the filter having a passband comprising a wavelength of the emitted radiation.

In another aspect, there is provided a method of inputting information into an interactive input system, the method comprising illuminating a region of interest with at least one first light source emitting radiation having a first wavelength, the region of interest being at least partially surrounded by a bezel having a surface absorbing the emitted radiation, the first light source being alternated between on and off states to give rise to first and second illuminations, capturing image frames of the region of interest and the bezel under the first and second illuminations, and processing the image frames by subtracting image frames captured under the first and second illuminations from each other for locating a pointer positioned in proximity with the region of interest.

### BRIEF DESCRIPTION OF THE DRAWINGS

Embodiments will now be described more fully with reference to the accompanying drawings in which:

FIG. 1 is a schematic perspective view of an interactive input system;

FIG. 2 is a block diagram of an imaging assembly forming part of the interactive input system of FIG. 1;

FIG. 3 is a schematic diagram of the imaging assembly of FIG. 2 and bezel segment forming part of the interactive input system of FIG. 1;

FIG. 4 is a graphical plot of the transmission spectrum of a filter forming part of the imaging assembly of FIG. 2;

FIG. 5 is a block diagram of a digital signal processor forming part of the interactive input system of FIG. 1;

FIG. 6 is a graphical plot of the absorption spectrum of an absorbing material employed by the bezel segments;

FIG. 7 is a flowchart showing steps in a pointer location method performed by the interactive input system of FIG. 1;

FIG. 8 is a schematic diagram of another imaging assembly for use in the interactive input system of FIG. 1; and

FIGS. 9a and 9b are side views of a fluorescent pointer for use with the interactive input system of FIG. 8, under fluorescing and non-fluorescing conditions, respectively.

### DETAILED DESCRIPTION OF THE EMBODIMENTS

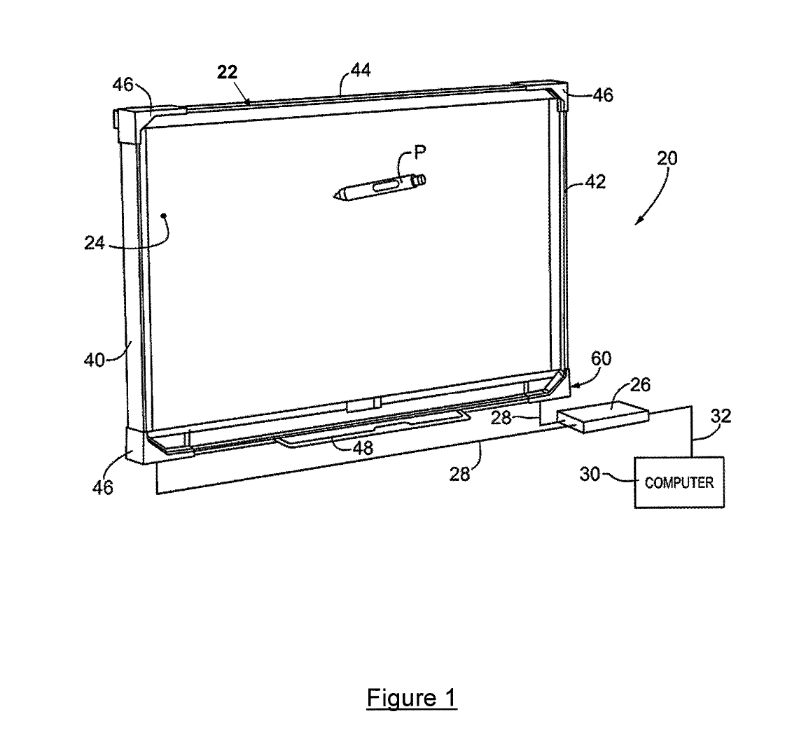

Turning now to FIG. 1, an interactive input system that allows a user to inject input such as digital ink, mouse events etc. into an application program is shown and is generally identified by reference numeral 20. In this embodiment, interactive input system 20 comprises a display unit (not shown) including a display surface 24 surrounded by an assembly 22 and in communication with a digital signal processor (DSP) unit 26. Assembly 22 engages the display unit such as for example, a plasma television, a liquid crystal display (LCD) device, a flat panel display device, a cathode ray tube, (CRT) monitor etc. Assembly 22 employs machine vision to detect pointers brought into a region of interest in proximity with the display surface 24. The assembly 22 communicates with the DSP unit 26 via communication lines 28. The communication lines 28 may be embodied in a serial bus, a parallel bus, a universal serial bus (USB), an Ethernet connection or other suitable wired connection. Alternatively, the assembly 22 may communicate with the DSP unit 26 over a wireless connection using a suitable wireless protocol such as for example Bluetooth, WiFi, ZigBee, ANT, IEEE 802.15.4, Z-Wave etc. The DSP unit 26 in turn communicates with a general purpose computing device 30 executing one or more application programs via a USB cable 32. Alternatively, the DSP unit 26 may communicate with the general purpose computing device 30 over another wired connection such as for example, a parallel bus, an RS-232 connection, an Ethernet connection etc. or may communicate with the general purpose computing device 30 over a wireless connection using a suitable wireless protocol such as for example Bluetooth, WiFi, ZigBee, ANT, IEEE 802.15.4, Z-Wave etc. General purpose computing device 30 processes the output of the assembly 22 received via the DSP unit 26 and adjusts image data that is output to the display unit so that the image presented on the display surface 24 reflects pointer activity. In this manner, the assembly 22, DSP unit 26 and the general purpose computing device 30 allow pointer activity proximate to the display surface 24 to be recorded as writing or drawing or used to control execution of one or more application programs executed by the general purpose computing device 30.

Assembly 22 comprises a frame assembly that is mechanically attached to the display unit and surrounds the display surface 24. Frame assembly comprises a bezel having three bezel segments 40, 42 and 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more pen tools P. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 accommodate imaging assemblies 60.

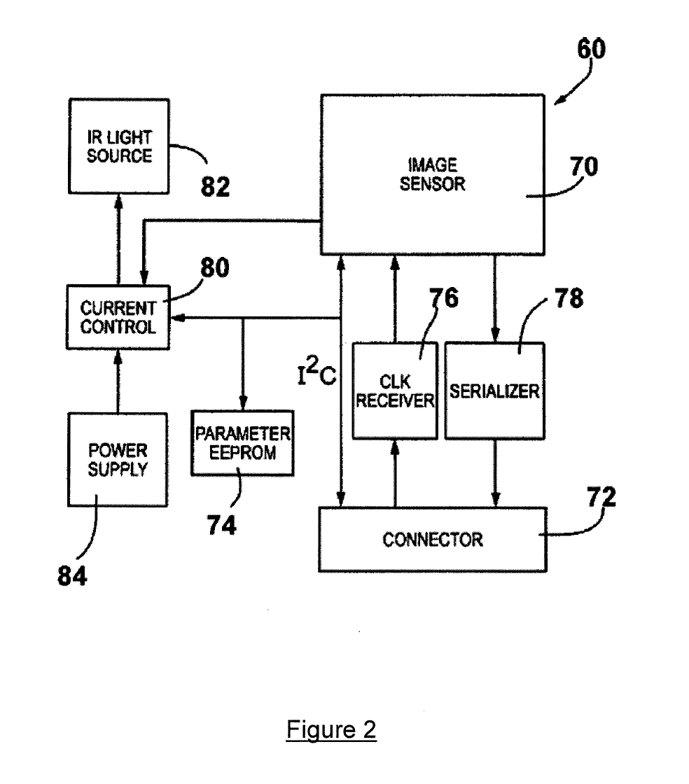

Turning now to FIG. 2, one of the imaging assemblies 60 is better illustrated. As can be seen, the imaging assembly 60 comprises an image sensor 70 fitted with an optical lens 70a having a bandpass filter thereon. The lens 70a provides the image sensor 70 with approximately a 98 degree field of view so that the entire display surface 24 is seen by the image sensor 70. The image sensor 70 is connected to a connector 72 that receives one of the communication lines 28 via an I²C serial bus. The image sensor 70 is also connected to an electrically erasable programmable read only memory (EEPROM) 74 that stores image sensor calibration parameters as well as to a clock (CLK) receiver 76, a serializer 78 and a current control module 80. The clock receiver 76 and the serializer 78 are also connected to the connector 72. Current control module 80 is also connected to an infrared (IR) light source 82 as well as to a power supply 84 and the connector 72.

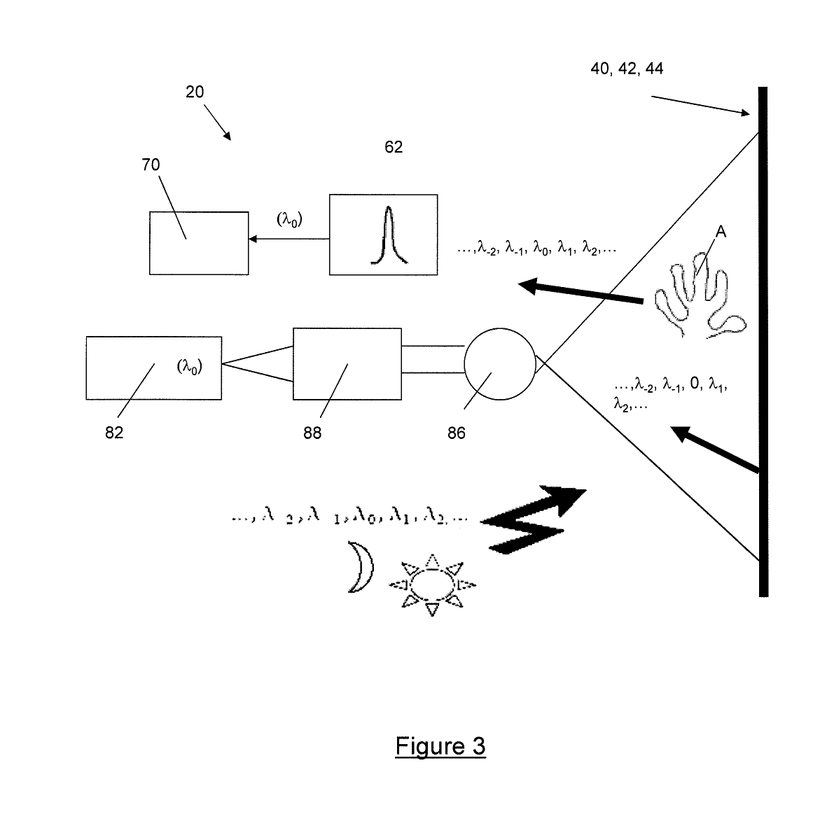

In this embodiment, the IR light source 82 comprises a plurality of monochromatic IR light emitting diodes (LEDs) 84 (see FIG. 3) emitting a diverging beam of IR light at a wavelength λ₀. A light collimating lens or collimator 86 is used to focus the diverging beam into a narrow beam of intense illumination. A second stage lens 88 spreads the narrow beam in two directions at an angle of about 90 degrees to form a fan of projected IR light that floods the region of interest over the display surface and illuminates the bezel segments 40, 42 and 44 with sufficient intensity so that when a pointer is positioned in proximity with the display surface 24, the IR light reflects off of the pointer towards the imaging assemblies 60 allowing the pointer to appear in image frames captured by imaging assemblies 60. Alternatively, the IR light source 82 can be modulated to further attenuate direct light from external sources that matches the wavelength of the bandpass filter 70b.

The clock receiver 76 and serializer 78 employ low voltage, differential signaling (LVDS) to enable high speed communications with the DSP unit 26 over inexpensive cabling. The clock receiver 76 receives timing information from the DSP unit 26 and provides clock signals to the image sensor 70 that determines the rate at which the image sensor 70 captures and outputs image frames. Each image frame output by the image sensor 70 is serialized by the serializer 78 and output to the DSP unit 26 via the connector 72 and communication lines 28.

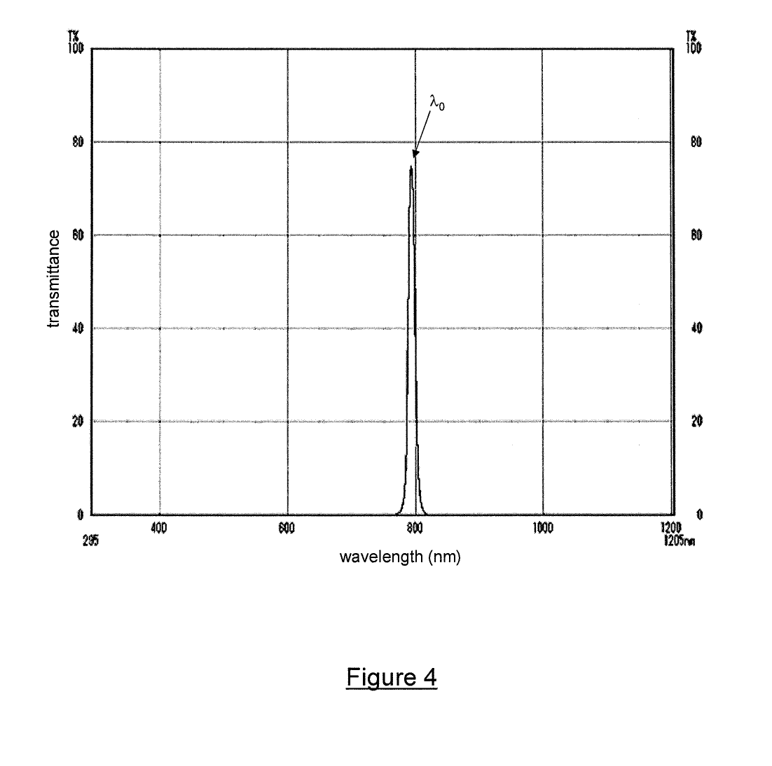

The bandpass filter 70b has a narrow pass band that is generally centered on the wavelength λ₀ of monochromatic infrared light emitted by the IR light sources 82. In this embodiment, the width of bandpass filter 70b is 8 nm and is centered at 790 nm, and has a transmittance of 75% to 80% at this center wavelength. The transmission spectrum of filter 62 is graphically plotted in FIG. 4.

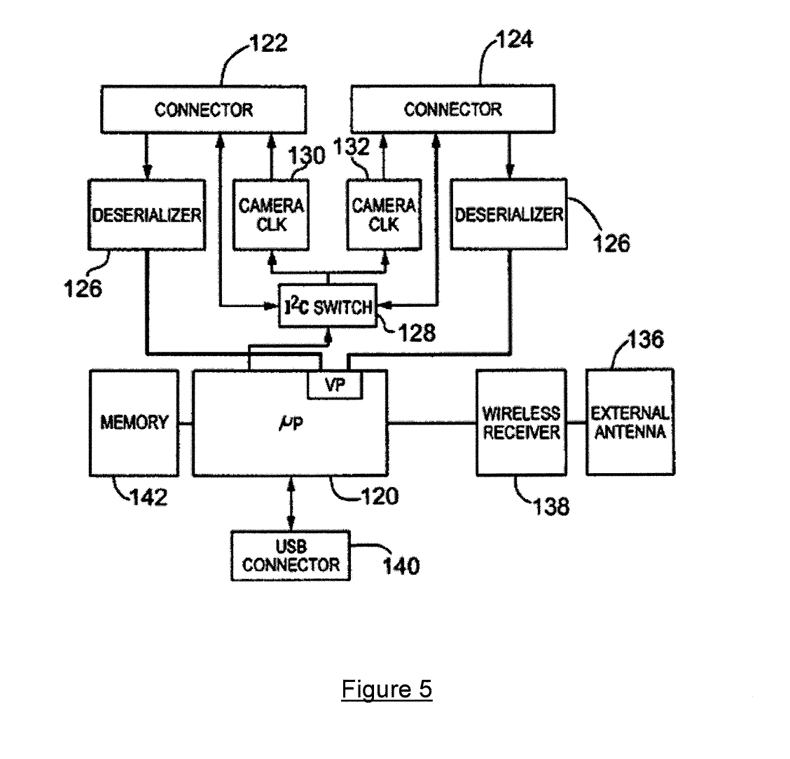

Turning now to FIG. 5, the DSP unit 26 is better illustrated. As can be seen, DSP unit 26 comprises a controller 120 such as for example, a microprocessor, microcontroller, DSP, other suitable processing structure etc. having a video port VP connected to connectors 122 and 124 via deserializers 126. The controller 120 is also connected to each connector 122, 124 via an I²C serial bus switch 128. I²C serial bus switch 128 is connected to clocks 130 and 132, each clock of which is connected to a respective one of the connectors 122, 124. The controller 120 communicates with a USB connector 140 that receives USB cable 32 and memory 142 including volatile and non-volatile memory. The clocks 130 and 132 and deserializers 126 similarly employ low voltage, differential signaling (LVDS).

The general purpose computing device 30 in this embodiment is a personal computer or the like comprising, for example, a processing unit, system memory (volatile and/or non-volatile memory), other non-removable or removable memory (e.g. a hard disk drive, RAM, ROM, EEPROM, CD-ROM, DVD, flash memory, etc.) and a system bus coupling the various computer components to the processing unit. The general purpose computing device may also comprise a network connection to access shared or remote drives, one or more networked computers, or other networked devices.

The interactive input system 20 is able to detect passive pointers such as for example, a user's finger, a cylinder or other suitable object as well as active pen tools P that are brought into proximity with the display surface 24 and within the fields of view of the imaging assemblies 60.

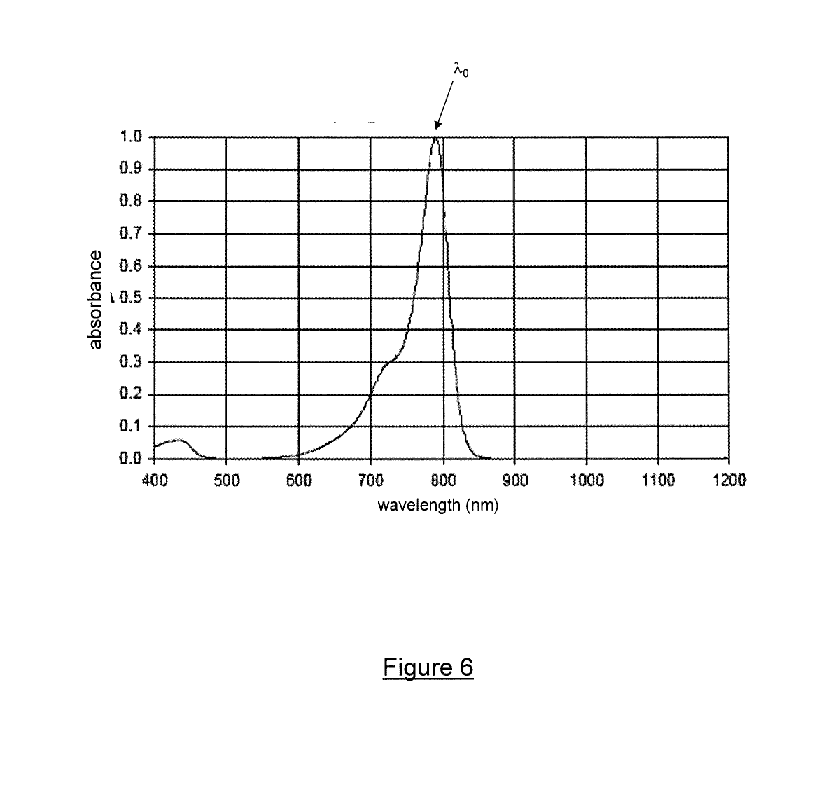

The inwardly facing surface of each bezel segment 40, 42 and 44 has an absorptive material disposed thereon that strongly absorbs infrared radiation in a wavelength range encompassing the wavelength λ₀ of IR radiation emitted by light sources 82. The emitted IR radiation from the IR light sources 82 is of sufficient intensity to illuminate a pointer brought into proximity with the display surface 24 but is absorbed by the absorptive material on the bezel segments which, as will be appreciated, creates a good contrast between the pointer and the background in captured image frames. In this embodiment, the absorptive material has an absorption range from 750 nm to 810 nm, and has an absorption peak at 790 nm. The absorption spectrum of the absorptive material is graphically plotted in FIG. 6. Other absorptive materials may be used, provided the absorption range encompasses the wavelength of IR radiation emitted by the IR light sources 82. To take best advantage of the properties of the absorptive material, the bezel segments 40, 42 and 44 are oriented so that their inwardly facing surfaces extend in a plane generally perpendicular to that of the display surface 24 and are seen by the imaging assemblies 60.

During operation, the controller 120 conditions the clocks 130 and 132 to output clock signals that are conveyed to the imaging assemblies 60 via the communication lines 28. The clock receiver 76 of each imaging assembly 60 uses the clock signals to set the frame rate of the associated image sensor 70. In this embodiment, the controller 120 generates clock signals so that the frame rate of each image sensor 70 is the same as the desired image frame output rate. The controller 120 also signals the current control module 80 of each imaging assembly 60 over the I²C serial bus. In response, each current control module 80 initially connects the IR light source 82 to the power supply 84 and then disconnects the IR light source 82 from the power supply 84. The timing of the on/off IR light source switching is controlled so that for any given sequence of successive image frames captured by each image sensor 70, one image frame is captured when the IR light sources 82 are on and the successive image frame is captured when the IR light sources 82 are off.

When the IR light sources 82 are on, the IR light sources 82 flood the region of interest over the display surface 24 with monochromatic infrared radiation having wavelength λ₀. The emitted IR radiation impinging on the bezel segments 40, 42 and 44 is absorbed by the absorptive material thereon and is not returned to the imaging assemblies 60. Ambient light having a range of wavelengths (e.g. . . . , λ₋₂, λ₋₁, λ_{0,} λ_{1,} λ₂, . . . ) impinging on the bezel segments 40, 42 and 44 is partially absorbed. In particular, the component of ambient light having wavelength λ₀ is absorbed by the absorptive material on the bezel segments 40, 42 and 44, while ambient light having a wavelength other than λ₀ (i.e. . . . , λ₋₂, λ₋₁, 0, λ_{1,} λ₂, . . . ) is reflected by the bezel segments towards the imaging assemblies 60. However, the ambient light at these wavelengths is blocked by the bandpass filters 70b inhibiting the ambient light from reaching the image sensors 70. As a result, in the absence of a pointer P, each imaging assembly 60 sees a dark band having a substantially even intensity over its length. If a pointer P is brought into proximity with the display surface 24, the pointer P reflects the IR radiation emitted by the IR sources 82, together with all wavelengths of ambient light (e.g. . . . , λ₋₂, λ₋₁, λ_{0,} λ_{1,} λ₂, . . . ) towards the imaging assemblies 60. The reflected IR radiation having wavelength λ₀ passes through bandpass filters 70b and reaches the image sensors 70. The ambient light at wavelengths other than λ₀ (i.e. . . . , λ₋₂, λ₋₁, 0, λ_{1,} λ₂, . . . ) is blocked by the bandpass filters 70b. As a result each imaging assembly 60 sees a bright region corresponding to the pointer P that interrupts the dark band in captured image frames.

When the IR light sources 82 are off, no infrared radiation having wavelength λ₀ floods the region of interest over the display surface 24. Only ambient light having a range of wavelengths (e.g. . . . , λ₋₂, λ₋₁, λ_{0,} λ_{1,} λ₂, . . . ) illuminates the region of interest over the display surface 24. As mentioned above, the component of ambient light having wavelength λ₀ that impinges upon the bezel segments 40, 42 and 44 will be absorbed. Although ambient light having wavelengths other than λ₀ (e.g. . . . , λ₋₂, λ₋₁, 0, λ_{1,} λ₂, . . . ) is reflected by the bezel segments towards the imaging assemblies 60, this ambient light is blocked by the bandpass filters 70b. As a result, image frames captured when the IR light sources 82 are off remain dark.

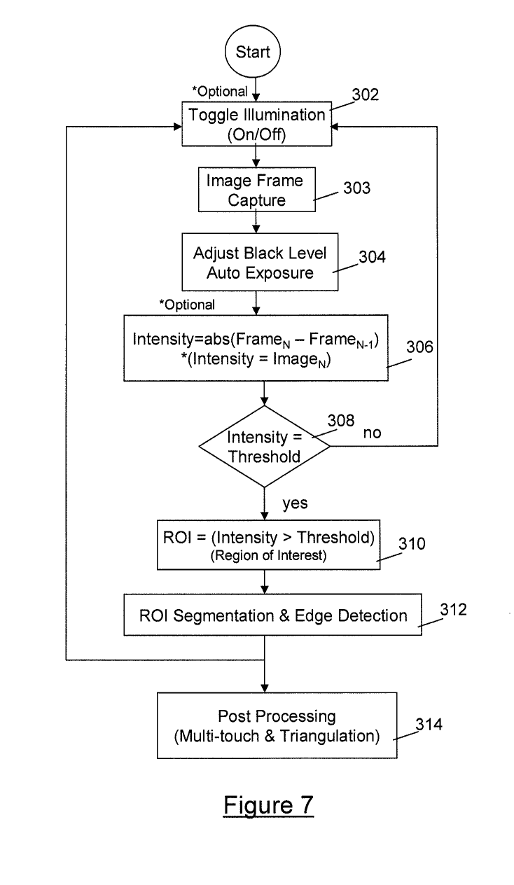

An overview of a pointer identification process used by the interactive input system 20, and which generally comprises the ambient light removal process, is illustrated in FIG. 7. DSP unit 26 toggles the IR light sources 82 to give rise to alternating illumination (step 302). Image frames are then captured by the imaging assemblies 60 under this alternating illumination, whereby one image frame is captured with the IR light sources 82 on and the successive image frame is captured with IR light sources 82 off (step 303). As the image frames are received by the DSP unit 26 from each imaging assembly 60, the DSP unit 26 adjusts the black level and the exposure level of each image frame (step 304), and the controller 120 stores this adjusted image frame in a buffer. Once two successive image frames are available, the DSP unit 26 measures an intensity value for each of the two frames, and then calculates a value of intensity by determining the absolute value of the difference of these two image frame values (step 306). Provided the frame rates of the image sensors 70 are high enough, both ambient light levels and display unit light levels will not change significantly between successive image frames and, as a result, ambient light having wavelength λ₀ is substantially cancelled by this calculation and will not influence the calculated intensity value.

Once the intensity value has been calculated it is compared to a threshold intensity value (step 308). If the calculated intensity value is less than the threshold intensity value, the DSP unit 26 assumes that a pointer is not present and the image frames stored in the buffer are discarded. If the calculated intensity value is greater than the threshold intensity value, the DSP unit 26 assumes that a pointer is present, and proceeds to examine the intensity of the image frame captured with IR light sources 82 on in order to identify the location of the pointer P (step 310).

The DSP unit 26 calculates normalized intensity values I(x) for the image frame captured with IR light sources 82 on. As will be appreciated, the intensity values I(x) remain low and uninterrupted for the pixel columns of the image frame corresponding to the regions where the bezel is not occluded by the pointer tip, and the I(x) values rise to high values at a region corresponding to the location of the pointer in this image frame.

Once the intensity values I(x) for the pixel columns of the image frame captured with IR light sources 82 on have been determined, the resultant I(x) curve for this image frame is examined to determine if the I(x) curve falls above a threshold value signifying the existence of a pointer P and if so, to detect left and right edges in the I(x) curve that represent opposite sides of a pointer P (step 312). In particular, one method which can be used in order to locate left and right edges in the image frame is to take both the first and second derivatives of the I(x) curve and locate the zero crossing of the second derivative where the absolute value of the magnitude of the first derivate exceeds a predetermined threshold. The point found when using this method is called the point-of-inflection for function I(x). The resultant curve I″(x) will include a zero crossing point for both the right and left edges of the pointer.

In this embodiment, the first and second derivatives of the I(x) curve are determined using polynomial approximations of the first and second derivative functions with added smoothing of undesired noise in the original signal. In particular, the first derivative curve I′(x) and second derivative curve I″(x) are approximated by numerical methods. The left and right edges, respectively, are then detected from the two zero crossing points of the resultant curve I″(x) where the absolute value of the magnitude of the first derivate curve I′(x) exceeds the predetermined threshold.

Having determined the left and right edges for the pointer P from the intensity function I(x) in the field of view of the imaging assemblies 60 using first and second derivatives of the I(x) curve, the midpoint between the identified left and right edges is then calculated to determine the location of the pointer P in the image frame. The controller 120 then defines a rectangular-shaped pointer analysis region that is generally centered on the pointer location.

At this stage, further analysis can be performed on the pointer analysis region to extract additional information such as texture, shape, intensity, statistical distribution or other identifying features of the pointer for motion tracking algorithms. This additional information may be useful for monitoring multiple pointers, which may occlude each other from view of one or more of the imaging assemblies 60 during use. Accordingly, such additional information may be used for correctly identifying each of the pointers as they separate from each other after such an occlusion. In the simplest form of motion tracking, only the left and right edges of each pointer are used for identifying each of the pointers. As will be appreciated, such further analysis is facilitated by the capturing image frames of the pointer against a dark background.

Once the location of the pointer P within the image frame has been determined, the controller 120 then calculates the position of the pointer P in (x,y) coordinates relative to the display surface 24 using well known triangulation (step 314), such as that described in above-incorporated U.S. Pat. No. 6,803,906 to Morrison et al. The calculated pointer coordinate is then conveyed by the controller 120 to the general purpose computing device 30 via the USB cable 32. The general purpose computing device 30 in turn processes the received pointer coordinate and updates the image output provided to the display unit, if required, so that the image presented on the display surface 24 reflects the pointer activity. In this manner, pointer interaction with the display surface 24 can be recorded as writing or drawing or used to control execution of one or more application programs running on the computer 30.

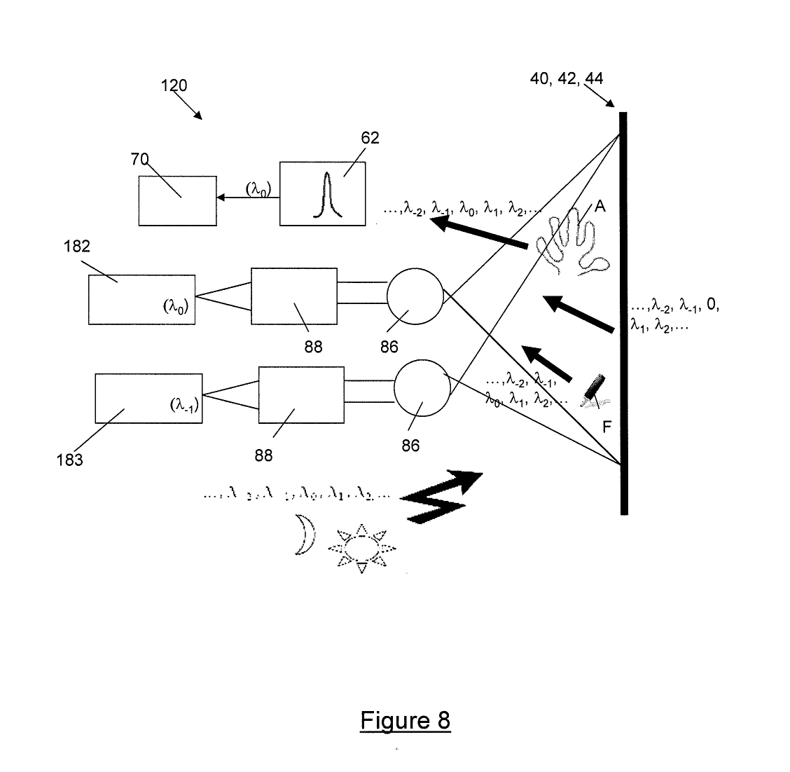

FIG. 8 schematically illustrates another embodiment of an imaging assembly for use in the interactive input system 20. Imaging assembly 160 is generally similar to that of the previous embodiment, but differs in that it comprises two infrared light sources 182 and 183 each emitting monochromatic infrared radiation having a different respective wavelength. Here, the IR light source 182 of each imaging assembly 160 emits radiation of a wavelength that matches the optical center frequency of the bandpass filter 70b, namely λ_{0,} while the IR light source 183 of each imaging assembly emits radiation of the wavelength that matches an excitation wavelength of a fluorescent material, namely λ₋₁. Operation of the IR light sources 182 and 183 is alternated such that when IR light sources 182 are on, the IR light sources 183 are off, and vice versa. The imaging assemblies 160 are synchronized with the IR light sources 182 and 183 such that successive image frames are captured using alternating illumination whereby, in a sequence of successively captured image frames, an image frame is captured when IR light sources 182 are turned on and IR light sources 183 are turned off is followed by an image frame captured when IR light sources 182 are turned off and IR light sources 183 are turned on.

The imaging assemblies 160 are particularly suited for use when fluorescent pointers F are used to interact with the display surface 24, where each pointer F has an area of its surface near the tip thereof covered with a fluorescent material. Fluorescent materials, such as phosphors and fluorescent dyes, are well known in the art. These materials absorb and are thereby excited by light at a first wavelength, and in turn emit light at a second, generally longer wavelength. In this embodiment, the fluorescent material on the pointers F absorbs the radiation emitted from IR light sources 183 having wavelength λ₋₁. In turn, the fluorescent material emits radiation having a longer wavelength, namely λ₀, by fluorescence. As will be appreciated, this radiation emitted by the fluorescent material may be used to distinguish fluorescent pointers F from passive pointers A, such as a finger or a palm.

When the IR light sources 182 are off and the IR light sources 183 are on, the IR light sources 183 flood the region of interest over the display surface 24 with monochromatic infrared radiation having wavelength λ₋₁. The emitted radiation of wavelength λ₁ impinging on the bezel segments 40, 42 and 44, is reflected by the bezel segments towards the imaging assemblies 60. Ambient light having a range of wavelengths (e.g. . . . , λ₋₂, λ₋₁, λ_{0,} λ_{1,} λ₂, . . . ) impinging on the bezel segments 40, 42 and 44 is partially absorbed and partially reflected as previously described. The component of the ambient light that is reflected and the reflected radiation of wavelength λ₋₁ is blocked by the bandpass filters 70b. As a result, in the absence of any pointers F or A, each imaging assembly 60 sees a dark band having a substantially even intensity over its length.

If a passive pointer A is brought into proximity with the display surface 24, the pointer A reflects the radiation emitted by the IR sources 183 together with ambient light (e.g. . . . , λ₋₂, λ₋₁, λ_{0,} λ_{1,} λ₂, . . . ). Ambient light of wavelength λ₀ reflected by the pointer A passes through the bandpass filters 70b and reaches image sensors 70. The reflected IR radiation and ambient light at wavelengths other then λ₀ are blocked by the bandpass filters 70b. However, if a fluorescent pointer F is brought into proximity with the display surface 24, the fluorescent material on the surface of pointer F absorbs the radiation emitted by the IR light sources 183 and in turn emits radiation at wavelength λ₀ by fluorescence. The emitted fluorescent radiation together with ambient light having wavelength λ₀ reflected by fluorescent pointer F, is admitted through the bandpass filters 70b and reaches the image sensors 70. As the intensity of the reflected ambient light of wavelength λ₀ is less than that of the IR radiation emitted by fluorescence, for the above scenarios each imaging assembly 60 sees a semi-bright region corresponding to pointer A and a bright region corresponding to the fluorescent pointer F that both interrupt the dark band in the captured image frames.

When the IR light sources 182 are on and the IR light sources 183 are off, the IR light sources 182 flood the region of interest over the display surface 24 with monochromatic infrared radiation having wavelength λ₀. Emitted radiation having wavelength λ₀ impinging on the absorptive bezel segments 40, 42 and 44 is absorbed and is not returned to the imaging assemblies 60. Ambient light having a range of wavelengths (e.g. . . . , λ₋₂, λ₋₁, λ_{0,} λ_{1,} λ₁, . . . ) impinging on the bezel segments 40, 42 and 44 will be partially absorbed. In particular, the component of ambient light having wavelength λ₀ will be absorbed while ambient light having wavelength other than λ₀ (i.e. . . . , λ₋₂, λ₋₁, 0, λ_{1,} λ₂, . . . ) will be reflected towards the imaging assembly 60. However, these wavelengths will be stopped by bandpass filters 70b and will not reach image sensors 70. As a result, in the absence of any pointers, each imaging assembly 60 sees a dark band having a substantially even intensity over its length. If a pointer A is brought into proximity with the display surface 24, the pointer reflects the radiation emitted from IR sources 182 and having wavelength λ_{0,} together with the ambient light (e.g. . . . , λ₋₂, λ₋₁, λ_{0,} λ_{1,} λ₂, . . . ), towards the imaging assemblies 60. If a fluorescent pointer F is also brought into proximity with the display surface 24, the fluorescent pointer F reflects the radiation emitted from IR sources 182 having wavelength λ₀, together with the ambient light (e.g. . . . , λ₋₂, λ₋₁, λ_{0,} λ_{1,} λ₂, . . . ), towards the imaging assemblies 60. The reflected IR radiation and the component of ambient light having wavelength λ₀ pass through the bandpass filters 70b and reach image sensors 70. The ambient light having wavelengths other than λ₀ (i.e. . . . , λ₋₂, λ₋₁, 0, λ_{1,} λ₂, . . . ) is stopped by bandpass filters 70b. As a result, for the above scenarios each imaging assembly 60 sees a bright region corresponding to the pointer A and a bright region corresponding to the fluorescent pointer F that both interrupt the dark band in captured image frames.

As will be appreciated, the use of two different illumination wavelengths that are readily separable through optical filtering allows fluorescing pointers to be differentiated from non-fluorescing pointers prior to image frame capturing, and therefore without relying only on image processing for the differentiation. This allows, for example, a users hand to be distinguished from a pointer tip coated with a fluorescent material, in a facile manner and without incurring computation costs for additional image processing.

The pointer identification process is similar to that described above for interactive input system 20. DSP unit 26 processes successive image frames output by the image sensor 70 of each imaging assembly 60, where successive image frames have been captured using alternating illumination, with one image frame having been captured with IR light sources 182 on and IR light sources 183 off and with the successive image in the sequence having been captured with IR light sources 82 off and IR light sources 183 on. Upon determination of the presence of one or more pointers, the DSP unit 26 calculates normalized intensity values I(x) for each of the captured image frames to determine the location of the pointers. Pointers existing only in an image frame captured when IR light sources 182 are on, but not in a successive image frame captured when IR light sources 182 are off, are identified as passive pointers A. Pointers existing both in an image frame captured when IR light sources 182 are on and in a successive image frame captured when IR light sources 182 are off are identified as fluorescent pointers F.

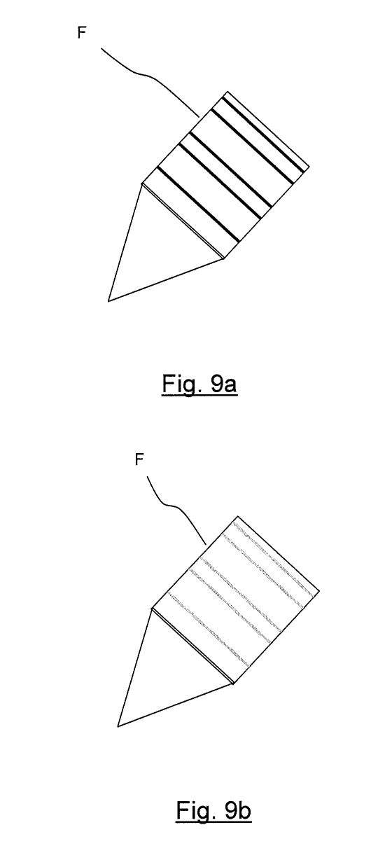

Different fluorescent pointers F can be distinguished from each other by arranging the fluorescent material in a unique pattern on the surface of each pointer. FIGS. 9a and 9b illustrate a fluorescent pointer F having fluorescent material arranged in a barcode pattern near the pointer tip, as viewed under fluorescing and non-fluorescing conditions, respectively. Under non-fluorescing conditions, the pattern of fluorescent material may be either invisible or only faintly visible. As the barcode pattern of a suitable size is discernable by imaging sensors 70, the use of a unique barcode pattern for individual fluorescent pointers F would allow multiple pointers to be readily monitored by the system. The fluorescent pointer F used with the system can have a single tip, such as that illustrated in FIGS. 9a and 9b. Alternatively, the pen tool P may have multiple tips, with each tip having a unique barcode pattern.

The interactive input system described above is not limited to only passive pointers and fluorescent pointers, and may also be used to monitor and track active pen tools that comprise a powered light source that emits illumination, where this emitted illumination may or may not be modulated. Since the bezel segments always appear dark in captured image frames due to their light absorptive properties, illumination emitted by an active pen tool would not cause interference with the background, as could be the case for an illuminated bezel. Additionally, the absorption of light by the bezel segments greatly reduces the appearance of shadows, which allows the location of the active pen tool to be determined more accurately. In this embodiment, the active pen tool would emit illumination having at least one component with wavelength λ₀, so as to be visible to the imaging sensors 70 through the filters 70b. The interactive input systems could also be configured to monitor and track active pen tools emitting modulated light and which would enable multiple active pen tools each having a different and uniquely modulated signal to be used. Other active pen tools, such as those described in U.S. Patent Application Publication No. 2009/0277697 to entitled “Interactive Input System and Pen Tool Therefor” could also be used with the interactive input system.

Although in embodiments described above, a bandpass filter is used for passing light of a single wavelength, in other embodiments, the filter may alternatively be applied as a coating to one or more individual elements of a pixel element array of the image sensor. Here, some pixel elements of the array may have the filter coating applied to them while others may have none, or may have still other filter coatings such as a monochrome filter or any of a RGB filter set. The pixel elements having the IR filter coating would be capable of imaging light of a single wavelength, while other pixel elements would be capable of imaging light of other wavelengths. Under modulated illumination, this configuration would allow for separate imaging of different wavelengths. This could enable, for example, the tracking and monitoring of multiple pointers each having a fluorescent material emitting a different fluorescent colour upon illumination by a common wavelength.

In another embodiment, the bezel segments could be marked with a registration pattern of an infrared fluorescent material. The pattern could be used advantageously for performing calibration of the imaging assemblies in the field and automatically upon startup, rather than during assembly. The markings could be invisible to a user and activated as needed with the correct excitation wavelength and modulation.

In another embodiment, the bezel segments could be formed by injection molding of a generally clear plastic having a fluorescing powder additive so as to form a light pipe. Here, a laser or LED providing emitting light capable of exciting the fluorescing powder could be optically coupled to the bezel segments to form a large fiber optic cable assembly that uses total internal reflection to trap the excitation light. Upon excitation, the fluorescing powder would emit another wavelength of light by fluorescence, which would not be trapped by total internal reflection. The imaging assemblies would be configured to see the fluoresced light. The excitation light could be modulated for allowing ambient light removal.

Although in the above described embodiments, the interactive input system comprises two imaging assemblies, in other embodiments, fewer or more imaging assemblies may alternatively be used. For example, interactive input systems utilizing four or more imaging assemblies, which have been described previously in U.S. Pat. No. 6,919,880, could also be used. Additionally, the assembly of the system can be duplicated, or tiled, so as to create larger touch surfaces as described in U.S. Pat. No. 7,355,593. As the purpose of the infrared absorbing material coated on the bezel segments is to prevent light from being reflected, there is no concern for the lack of bezel that would otherwise be located at the point of overlap.

Although in the embodiments described above, the imaging assemblies comprise IR light sources those of skill in the art will appreciate that the IR light sources are not required if there is substantial ambient light.

Although in the embodiments described above the light sources are modulated, the light sources are not limited to being modulated and in other embodiments may not be modulated to as provide constant or semi-constant illumination of the input region.

Although in the embodiments described above the light sources are configured to emit monochromatic radiation having wavelength λ₀, the light sources are not limited to monochromatic radiation and instead may be configured to emit radiation having a range of wavelengths and including wavelength λ₀.

Although in the embodiments described above, the IR light sources emit infrared radiation, the light sources are not limited to this range of wavelengths and in other embodiments; any wavelength of radiation may alternatively be emitted.

Although in the embodiments described above, the filter is a bandpass filter, the filter is not limited to the transmittance characteristics of a bandpass filter and in other embodiments may be a filter having different transmittance characteristics.

Similarly, although in the embodiments described above, the fluorescent material absorbs infrared light and emits infrared light, the fluorescent material is not limited to these wavelength ranges and in other embodiments may absorb and emit light in any wavelength range or ranges.

Similarly, although in the embodiments described above, the absorbing material absorbs infrared light, the absorbing material is not limited to this wavelength range and in other embodiments may absorb light in any wavelength range or ranges.

Although preferred embodiments have been described, those of skill in the art will appreciate that variations and modifications may be made without departing from the spirit and scope thereof as defined by the appended claims.

What is claimed is:

1. An interactive input system comprising:
at least one light source configured for emitting radiation into a region of interest;
a bezel at least partially surrounding the region of interest and having a surface in the field of view of the at least one imaging device, the surface absorbing the emitted radiation; and
at least one imaging device having a field of view looking through a filter and into the region of interest and capturing image frames, the filter having a passband comprising a wavelength of the emitted radiation.

2. The interactive input system of claim 1, wherein the emitted radiation is monochromatic.

3. The interactive input system of claim 1, wherein the emitted radiation is infrared radiation.

4. The interactive input system of claim 1, wherein the at least one light source is alternated between on and off states.

5. The interactive input system of claim 1, wherein the at least one light source comprises:
at least one first light source emitting radiation at a first wavelength; and
at least one second light source emitting radiation at a second wavelength, the first and second light sources being alternated to emit radiation at the first and second wavelengths alternatingly into the region of interest.

6. The interactive input system of claim 5, wherein the passband comprises the second wavelength.

7. The interactive input system of claim 5, wherein the surface of the bezel absorbs the second wavelength.

8. The interactive input system of claim 6, wherein the first wavelength is an excitation wavelength of a fluorescent material and the second wavelength is an emission wavelength of the fluorescent material.

9. The interactive input system of claim 8, wherein the fluorescent material is disposed on a pointer.

10. The interactive input system of claim 9, wherein the fluorescent material is spatially arranged in a pattern, the pattern being distinguishable by the processing structure for allowing the identity of the pointer to be determined.

11. The interactive input system of claim 7, wherein the first wavelength is an excitation wavelength of a fluorescent material and the second wavelength is an emission wavelength of the fluorescent material.

12. The interactive input system of claim 11, wherein the fluorescent material is disposed on a pointer.

13. The interactive input system of claim 12, wherein the fluorescent material is spatially arranged in a pattern, the pattern being distinguishable by the processing structure for allowing the identity of the pointer to be determined.

14. The interactive input system of claim 1, further comprising processing structure in communication with the at least one imaging device processing the image frames for locating a pointer positioned in proximity with the region of interest.

15. A method of inputting information into an interactive input system, the method comprising:
illuminating a region of interest with at least one first light source emitting radiation having a first wavelength, the region of interest being at least partially surrounded by a bezel having a surface absorbing the emitted radiation, the first light source being alternated between on and off states to give rise to first and second illuminations;
capturing image frames of the region of interest and the bezel under the first and second illuminations; and
processing the image frames by subtracting image frames captured under the first and second illuminations from each other for locating a pointer positioned in proximity with the region of interest.

16. The method of claim 15, wherein the radiation emitted by the first light source is monochromatic.

17. The method of claim 15, wherein the radiation emitted by the first light source is infrared radiation.

18. The method of claim 15, wherein the step of capturing comprises capturing the image frames through a filter having a passband comprising the first wavelength.

19. The method of claim 15, further comprising:
illuminating a region of interest with at least one second light source emitting radiation having a second wavelength, the second light source being alternated between on and off states, and the first and second light sources being alternated with respect to each other.

20. The method of claim 19, wherein the radiation emitted by any of the first and second light sources is monochromatic.

21. The method of claim 19, wherein the radiation emitted by any of the first and second light sources is infrared radiation.

22. The method of claim 19, wherein the step of capturing comprises capturing the image frames through a filter having a passband comprising the first wavelength.

23. The method of claim 15, wherein the second wavelength is an excitation wavelength of a fluorescent material and the first wavelength is an emission wavelength of the fluorescent material.

24. The method of claim 23, wherein the pointer comprises the fluorescent material.

25. The method of claim 24, wherein the fluorescent material is spatially arranged in a pattern, the pattern being distinguishable by the processing structure for allowing the identity of the pointer to be determined.
